(19) United States
(12) Patent Application Publication
(10) Pub. No.: US 2016/0277305 A1
(43) Pub. Date: Sep. 22, 2016

(54) INFORMATION PROCESSING APPARATUS AND METHOD FOR CONTROLLING THE SAME

(71) Applicant: CANON KABUSHIKI KAISHA, Tokyo (JP)

(72) Inventor: Katsutoshi Tajiri, Inagi-shi (JP)

(21) Appl. No.: 15/071,039

(22) Filed: Mar. 15, 2016

(30) Foreign Application Priority Data
Mar. 18, 2015 (JP) 2015-055209

(51) Int. Cl. H04L 12/911

(52) U.S. Cl. CPC H04L 47/70

(57) ABSTRACT

An information processing apparatus includes an information management unit configured to acquire load information at a first interval, a transmission unit configured to transmit the load information acquired by the information management unit to an external apparatus via a network at a second interval, a reception unit configured to receive a control command including an instruction or a parameter required to acquire the load information via the network, and a control unit configured to control the first interval or the second interval. The control unit controls the first interval or the second interval based on a change amount of the load information.

The present disclosure also provides a related control method.

### BACKGROUND

1. Technical Field

The present disclosure relates to an information processing apparatus and a method for controlling the information processing apparatus. More particularly, the present disclosure relates to an information processing apparatus that performs processing for transmitting load information to an external apparatus.

2. Description of the Related Art

Recently, numerous information processing apparatuses are connected via a network in such a way as to constitute a large-scale information processing system. To improve performances of such an information processing system, recognizing each information processing apparatus connected to the network and managing an operational state thereof becomes more important.

For example, as discussed in Japanese Patent Application Laid-Open No. 2000-57073, a plurality of information processing apparatuses connected via a network can cooperatively constitute a hierarchical management information group, in which a management apparatus can periodically acquire most significant management information and can hierarchically search for a change of the management information.

Further, a command group that is required to access a network and control video streaming is installed on an imaging apparatus that is an example of the information processing apparatus. The standard formulated by Open Network Video Interface Forum (ONVIF) is conventionally known as an example of the above-mentioned command group.

### SUMMARY

The present disclosure is directed to an information processing apparatus that can communicate with an external apparatus via a network. The information processing apparatus includes an information management unit configured to acquire load information at a first interval, a transmission unit configured to transmit the load information acquired by the information management unit to the external apparatus via a network at a second interval, a reception unit configured to receive a control command including an instruction or a parameter required to acquire the load information via the network, and a control unit configured to control the first interval or the second interval. The control unit controls the first interval or the second interval based on a change amount of the load information.

Further features of the present disclosure will become apparent from the following description of exemplary embodiments with reference to the attached drawings.

### BRIEF DESCRIPTION OF THE DRAWINGS

FIGS. 1A and 1B are diagrams illustrating a network configuration including an information processing apparatus according to an exemplary embodiment.

FIG. 2 is a block diagram illustrating an information processing apparatus according to an exemplary embodiment.

FIG. 3 is a block diagram illustrating an internal configuration of a client apparatus according to an exemplary embodiment.

FIG. 4 is a block diagram illustrating an internal configuration of a control unit according to an exemplary embodiment.

FIG. 5 is a sequence diagram according to an exemplary embodiment.

FIGS. 6A, 6B, and 6C are examples of command structures according to an exemplary embodiment.

FIGS. 7A and 7B are flowcharts illustrating load information management processing according to a first exemplary embodiment.

FIG. 8 is a flowchart illustrating load information management processing according to a second exemplary embodiment.

### DESCRIPTION OF THE EMBODIMENTS

Exemplary embodiments of the present disclosure will be described in detail below with reference to the drawings.

Configurations described in the following exemplary embodiments are mere examples. The present disclosure is not limited to the illustrated configurations. Further, it is assumed that commands in the following exemplary embodiments are determined based on the Open Network Video Interface Forum (ONVIF) standard.

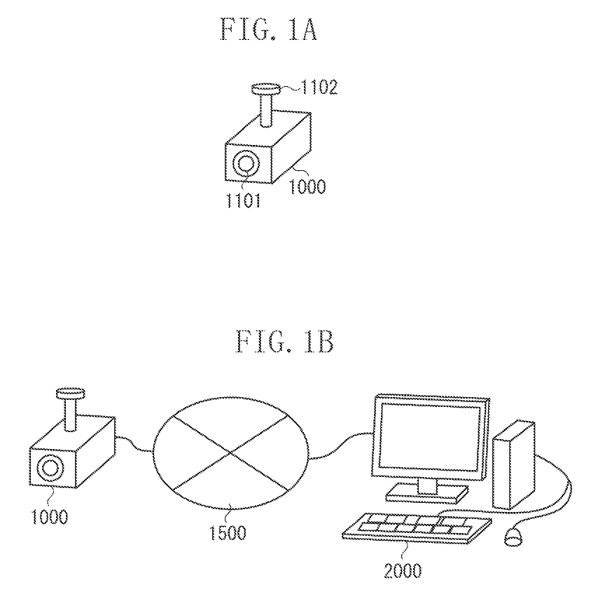

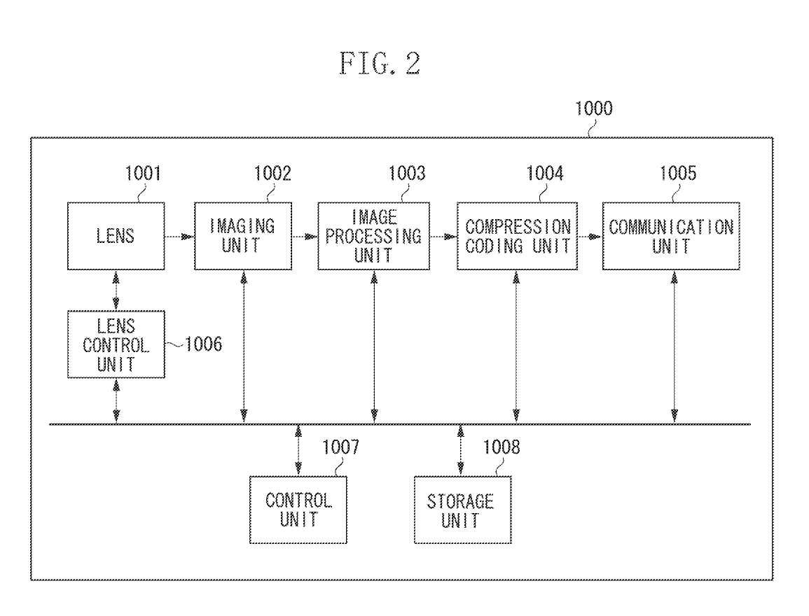

Hereinafter, a network configuration according to a first exemplary embodiment of the present disclosure will be described in detail below with reference to FIGS. 1A and 1B.

FIG. 1A illustrates an imaging apparatus 1000 according to an exemplary embodiment of the present disclosure. A housing 1101 includes a lens. An arm mechanism 1102 can determine the azimuth of the imaging apparatus 1000 in a panning direction and a tilting direction, when the housing 1101 is hung from an upper portion (e.g., a ceiling) with reference to installation place and shooting angle.

FIG. 1B is a system configuration diagram that includes the imaging apparatus 1000. A client apparatus 2000 serves as an external device in the present disclosure. The imaging apparatus 1000 and the client apparatus 2000 are connected via an IP network 1500 and can communicate with each other. The client apparatus 2000 can transmit various commands, including an imaging parameter change command and a video streaming start command, to the imaging apparatus 1000. The imaging apparatus 1000 can transmit a response to each command and a video streaming to the client apparatus 2000.

The imaging apparatus 1000 according to the present exemplary embodiment is an example of an information processing apparatus that can communicate with an external apparatus via a network. For example, the imaging apparatus 1000 is a monitoring camera that can capture a moving image. More specifically, the imaging apparatus 1000 is a camera server (i.e., a network camera) that can be used for monitoring. The client apparatus 2000 according to the present exemplary embodiment is an example of the external apparatus (e.g., a personal computer (PC)). The monitoring system according to the present exemplary embodiment can serve as an imaging system. Although only one imaging apparatus is provided in FIG. 1B includes, the network configuration can include two or more imaging apparatuses. Further, in addition to the client apparatus 2000, the network configuration can include another client apparatus that is capable of accessing and controlling the imaging apparatus 1000 and receiving captured images.

Further, it is assumed that the IP network 1500 is constituted by a plurality of routers, switches, and cables, which satisfy a predetermined communication standard (e.g., Ethernet (registered trademark)). However, in the present exemplary embodiment, the IP network 1500 is not specifically restricted in the communication standard, scale, and configuration, as long as the IP network 1500 enables the imaging apparatus 1000 and the client apparatus 2000 to perform communications.

For example, the IP network 1500 can be constituted by Internet, a wired Local Area Network (LAN), a wireless LAN (Wireless LAN), or a wide area network (WAN). The imaging apparatus 1000 according to the present exemplary embodiment can be configured to conform to Power Over Ethernet (PoE (registered trademark)), and can be configured to receive electric power via a LAN cable.

FIG. 2 is a block diagram illustrating an internal configuration of the imaging apparatus 1000 according to the present exemplary embodiment. As illustrated in FIG. 2, the imaging apparatus 1000 includes a lens 1001, an imaging unit 1002, an image processing unit 1003, a compression coding unit 1004, a communication unit 1005, a lens control unit 1006, a control unit 1007, and a storage unit 1008.

Operations that can be performed by the imaging apparatus 1000 according to the present exemplary embodiment will be described in detail below with reference to FIG. 2. The light from an imaging object is input via the lens 1001 to the imaging unit 1002. The imaging unit 1002 forms an image of the imaging object, which can be output as a video signal. The lens control unit 1006 performs control processing for the input video signal, which includes changing a diaphragm of the lens 1001, adjusting the focus position, and inserting an infrared ray cut filter according to the image of the object to be captured. The image processing unit 1003 can receive the video signal from the imaging unit 1002.

The imaging apparatus 1000 illustrated in FIG. 2 includes a communication unit 1005 that can receive control commands, including video size setting instruction and a setting command relating to exposure control (e.g., white balance and gain) for the imaging object image, from the client apparatus 2000. The setting command for the image can be analyzed by the control unit 1007 and input to the image processing unit 1003. At the same time, the image setting information can be stored in the storage unit 1008. When the imaging apparatus 1000 is activated, the control unit 1007 performs settings for the image processing unit 1003 according to the image setting information stored in the storage unit 1008. The image processing unit 1003 can perform image processing according to the image setting information. The compression coding unit 1004 can receive a processing signal from the image processing unit 1003.

The communication unit 1005 illustrated in FIG. 2 can receive various control commands, including a coding setting command, from the client apparatus 2000. The coding setting command can be analyzed by the control unit 1007 and stored in the storage unit 1008. The compression coding unit 1004 can receive the coding setting command from the storage unit 1008. The above-mentioned coding setting information includes designated information, such as coding method, image size, rotation of image, and resolution of image. The compression coding unit 1004 can perform compression coding processing on the imaging object image input from the image processing unit 1003 according to a designated coding method, with reference to a plurality of designated image sizes or resolutions of the image.

By performing the above-mentioned operations, the imaging apparatus 1000 according to the present exemplary embodiment can distribute image streams of the same scene according to different coding methods and different image sizes substantially simultaneously. The image streams can be output to an external device via the communication unit 1005.

Further, the communication unit 1005 illustrated in FIG. 2 can receive the control commands, including a factory default command, from the client apparatus 2000. The factory default command can be analyzed by the control unit 1007 after it is received by the communication unit 1005. The control unit 1007 can update various setting information stored in the storage unit 1008 with reference to factory default settings stored in the storage unit 1008. For example, the above-mentioned image setting information and coding setting information can be updated with reference to the factory default settings.

Further, the control unit 1007 includes a central processing unit (CPU), which can control each constituent component of the client apparatus 2000 and can set various parameters. The storage unit 1008 includes a memory that can electrically erase the stored data. The control unit 1007 can execute the OS and various programs loaded from the memory of the storage unit 1008. The memory can be used as a storing area for the programs and a work area for the control unit 1007 when it executes each program, and a storing area for various data. Further, the control unit 1007 includes a timer unit that can measure a designated period of time. The control unit 1007 causes the timer unit to measure a period designated by a control command from the client apparatus 2000 and measure an operation period of the own apparatus. Further, the control unit 1007 is capable of detecting a state change occurring in the imaging apparatus 1000 as an event. For example, a change of an imaging object in a captured image and a positional change of the lens 1001 are events that the control unit 1007 can detect.

In addition, the storage unit 1008 holds initial values of various parameters (i.e., setting information) that the control unit 1007 uses to control the imaging apparatus 1000. The initial values can be referred to in an event of reception of an initialization command. More specifically, if the imaging apparatus 1000 receives the initialization command, the imaging apparatus 1000 updates the latest setting information, including the information having been set by the client apparatus 2000 after installation and operation of the imaging apparatus 1000 for a significant period of time, with reference to the initial values held in the storage unit 1008.

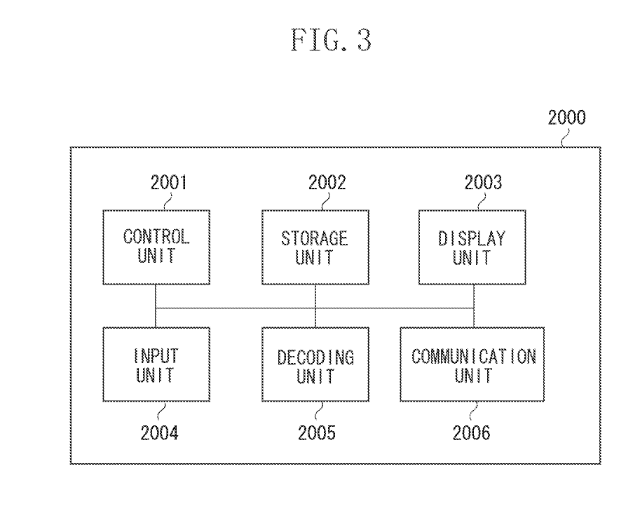

FIG. 3 illustrates an internal configuration of the client apparatus 2000.

As illustrated in FIG. 3, the client apparatus 2000 includes a control unit 2001. For example, the control unit 2001 is constituted by a CPU, which can control various operations to be performed by the client apparatus 2000.

The client apparatus 2000 includes a storage unit 2002. The storage unit 2002 can be used as a storing area for programs that the control unit 2001 mainly executes, a work area for a running program, and a storing area for various data.

The client apparatus 2000 includes a display unit 2003. The display unit 2003 is, for example, constituted by a liquid crystal device (LCD) or an organic EL display device. The display unit 2003 can display various setting screens (including a streaming image setting screen), a video viewer received from the imaging apparatus 1000, and various messages, for a user of the client apparatus 2000.

The client apparatus 2000 includes an input unit 2004. For example, the input unit 2004 can be constituted by buttons, a four-way operational key, a touch panel, and a mouse. The input unit 2004 can notify the control unit 2001 of the content of each user's screen operation.

The client apparatus 2000 includes a decoding unit 2005. The decoding unit 2005 can decode compression coded image data received via a communication unit 2006 based on the JPEG or H.264 format and develop the decoded image data in the storage unit 2002.

The communication unit 2006 can be used when the client apparatus 2000 transmits each control command to the imaging apparatus 1000. Further, the communication unit 2006 can be used when a response to the control command or a video stream is received from the imaging apparatus 1000.

Although the internal configurations of the imaging apparatus 1000 and the client apparatus 2000 have been described with reference to FIGS. 2 and 3, the processing blocks illustrated in FIGS. 2 and 3 are mere examples of the imaging apparatus and the client apparatus according to a preferred exemplary embodiment of the present disclosure and do not intend to narrowly limit the scope of the present disclosure. The internal configurations can be changed or modified in various ways within the scope of the present disclosure. For example, it is possible to provide a sound input unit and a sound output unit.

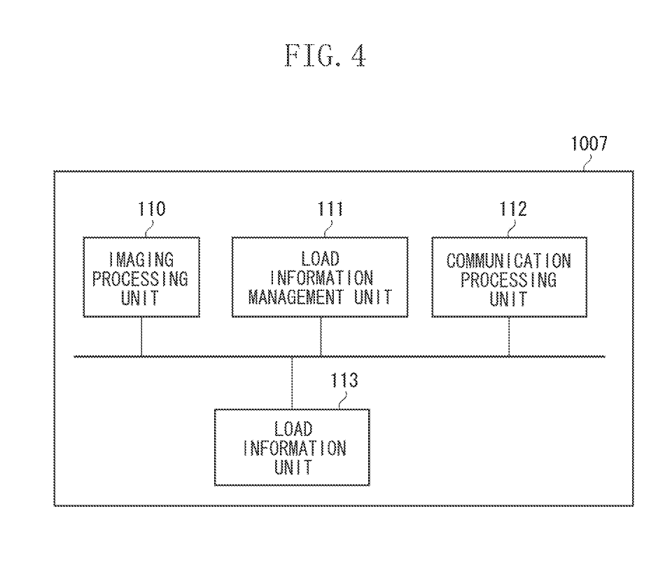

FIG. 4 is a diagram illustrating an internal configuration of the control unit 1007. The control unit 1007 of the imaging apparatus 1000 includes an imaging processing unit 110, a load information management unit 111, a communication processing unit 112, and a load information unit 113.

The imaging processing unit 110 can acquire image data generated by the imaging unit 1002, via the image processing unit 1003, and perform image processing and coding processing on the acquired image data according to image quality parameters. Further, the imaging processing unit 110 can transmit the processed image data to the communication processing unit 112. In the present exemplary embodiment, the imaging processing unit 110 is not an essential component and can be omitted.

The load information management unit 111 can acquire apparatus load information (e.g., usage rate of the CPU included in the control unit 1007) and apparatus internal event information, from the load information unit 113, at predetermined intervals or in response to detection of an event. Further, the load information management unit 111 can transmit the acquired information to the communication processing unit 112. The apparatus internal event information includes initial setting return date and time, start-up/restart date and time, time synchronization date and time, backup date and time, own apparatus fan/power/storage error, or temperature abnormality.

The time to transmit the information to the communication processing unit 112 is not limited to the above-mentioned predetermined intervals and can be a detection timing of a variation in CPU usage rate or an occurrence timing of an internal event. Further, the above-mentioned predetermined intervals can be changed according to the load information or the occurrence of an internal event.

In response to a request from an arbitrary client, the communication processing unit 112 temporarily stores image data received from the imaging processing unit 110, apparatus load information received from the load information management unit 111, and internal event information in the storage unit 1008. Then, the control unit 1007 controls the communication unit 1005 to transmit the temporarily stored data and information to the requested client.

The load information unit 113 can collect the apparatus load information (e.g., usage rate of the CPU included in the control unit 1007) and the apparatus internal event information and can calculate new information based on the collected information. The load information unit 113 can store the new information. If necessary, the load information management unit 111 can acquire the information stored in the load information unit 113. The load information unit 113 can be configured to input information written from the load information management unit 111.

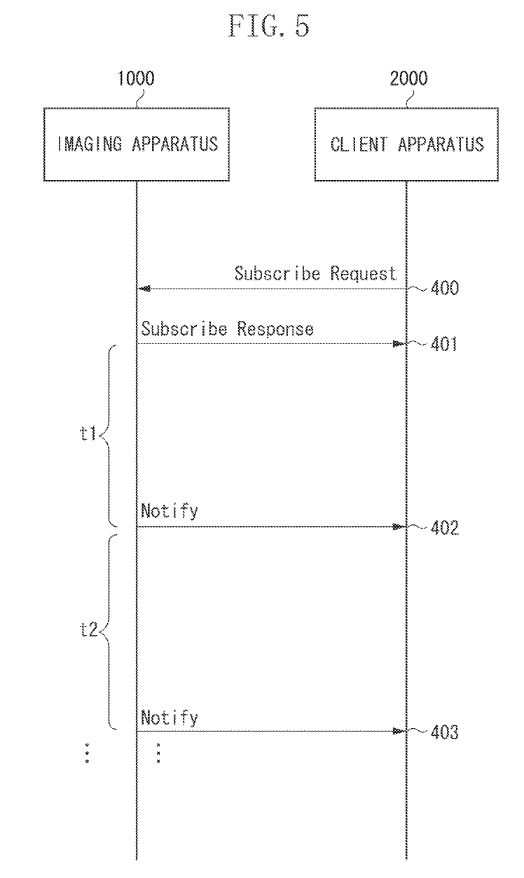

FIG. 5 illustrates a sequence of control commands used in the communications between the imaging apparatus 1000 and the client apparatus 2000.

In step 400, the client apparatus 2000 transmits a Subscribe Request command that includes load information to be acquired or internal event information (hereinafter, referred to as load information) to the imaging apparatus 1000. The client apparatus 2000 can include interval information (as a parameter requesting periodically notifying the load information) or expiration information about a valid period (or an expiration time) for repeating the notification, as part of the Subscribe Request command.

In step 401, the imaging apparatus 1000 acquires load information about own apparatus and transmits a Subscribe Response command including the acquired information to the client apparatus 2000. The Subscribe Response command transmitted by the imaging apparatus 1000 in this case can include the interval information indicating repetitively notifying the load information, as a parameter.

In step 402, the imaging apparatus 1000 acquires load information after the elapse of time t1, which is included in the interval information requested from the client apparatus 2000 or in interval information owned by the camera, and transmits a Notify command including the acquired load information to the client apparatus 2000. The elapse of time t1 can be measured by the timer unit included in the control unit 1007. After the elapse of time t1, the timer unit included in the control unit 1007 transmits a predetermined notification to the CPU included in the control unit 1007, to notify the elapse of the period.

After the elapse of time t2, namely in step 403, the imaging apparatus 1000 transmits a Notify command including load information based on the interval information. In this case, the time t2 can be the same as the time t1 or different from the time t1. Alternatively, the imaging apparatus 1000 can transmit the Notify command in response to the occurrence of an internal event.

In a case where a valid period is designated beforehand, the imaging apparatus 1000 stops transmitting the Notify command after the elapse of the valid period.

The present exemplary embodiment has been described on the presupposition that the client knows the load information to be acquired or internal event information beforehand. However, the client apparatus 2000 can acquire a list of load information or internal event information acquirable from the imaging apparatus 1000 beforehand by using a predetermined request instruction command and then transmit the Subscribe Request command.

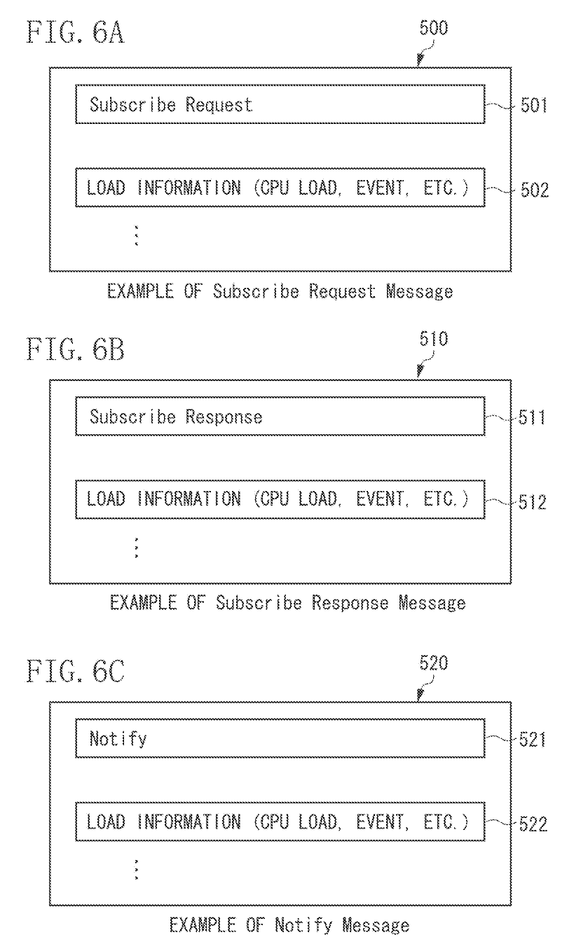

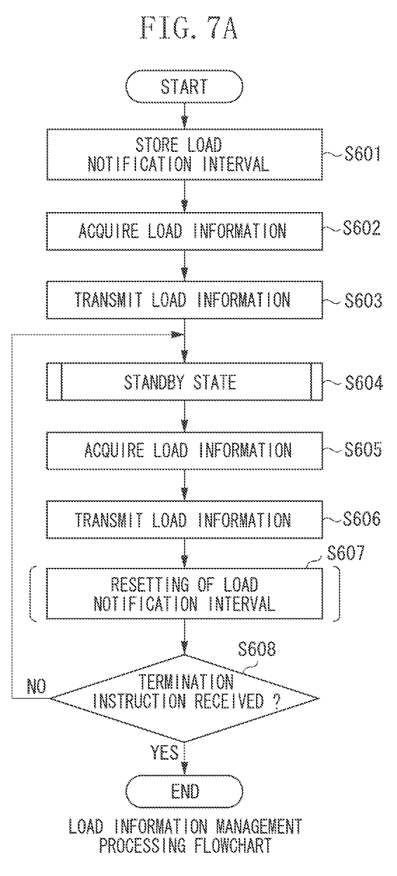

FIGS. 6A, 6B, and 6C illustrate structures of the Subscribe Request command, the Subscribe Response command, and the Notify command used in the sequence illustrated in FIG. 5. In FIGS. 6A, 6B, and 6C, address information indicating an address of each control command and a sequence number assuring a transmission/reception order are not included in the illustrated command structures.

FIG. 6A illustrates an example of Subscribe Request command 500. The Subscribe Request command 500 includes a field 501 indicating that command 500 is the Subscribe Request command and a field 502 indicating load information to be acquired. For example, CPU usage rate and memory usage rate are examples of the apparatus load information that can be designated as the load information to be acquired. Further, initial setting return date and time, start-up/restart date and time, time synchronization date and time, and backup date and time are examples of the apparatus internal event information that can be designated as the load information to be acquired. In addition, own apparatus fan/power/storage error and temperature abnormality can be designated as the load information to be acquired. Although the command structure illustrated in FIG. 6A includes only the load information to be acquired, the command structure can additionally include an interval information field and a valid period information field.

The interval information can include a time interval at which notification of the load information is performed, a time interval at which apparatus internal load information is confirmed, and information indicating whether to promptly notify an internal event if it occurs. The valid period information can include a valid period during which the load information should be notified. The valid period can be actual time (e.g., Coordinated Universal Time (UTC) or local time) or can be relative time indicating elapsed time since the present time.

FIG. 6B illustrates an example of Subscribe Response command 510. The Subscribe Response command 510 includes a field 511 indicating that the command 510 is the Subscribe Response command and a field 512 indicating load information acquired from the imaging apparatus 1000. The load information 512 includes information about an actual camera corresponding to the load information requested by the Subscribe Request command. Although the command structure illustrated in FIG. 6B includes only the acquired load information, the command structure can additionally include the interval information. The interval information can be a value relating to the content of the Subscribe Request command or can be a value not related to the request and determined in the imaging apparatus 1000.

FIG. 6C illustrates an example of Notify command 520. The Notify command 520 includes a field 521 indicating that the command 520 is the Notify command and a field 522 indicating the load information of the imaging apparatus 1000. The load information 522 is identical to the load information 512 in the Subscribe Response command 510.

A plurality of pieces of load information can be designated by the Subscribe Request command 500. In this case, it is possible to designate notification time interval or timing for individual load information. Further, the Subscribe Response command 510 can include information relating to individual load information designated by the Subscribe Request command 500. If necessary, the Notify command 520 can be transmitted for individual load information at appropriate timing. If there is a plurality of pieces of load information Notify commands 520 to be transmitted at the same time, it is possible to transmit a single control command including all of them. Alternatively, it is possible to transmit the notifications sequentially according to a predetermined priority order.

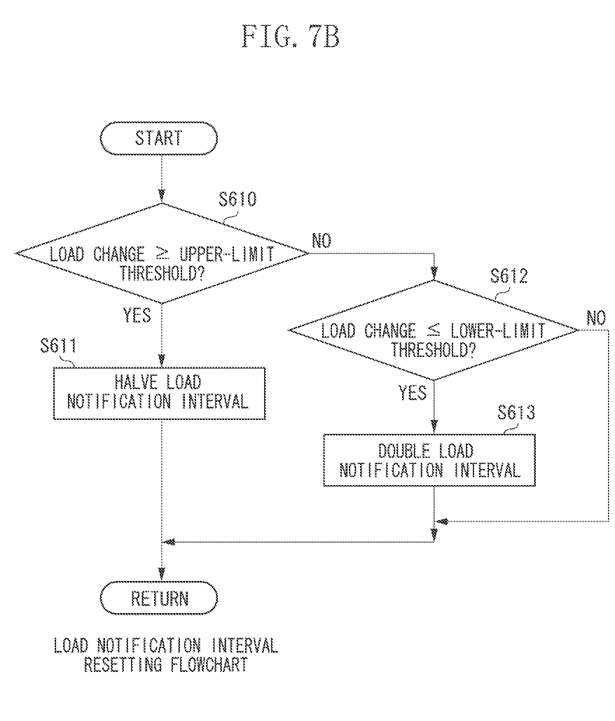

FIG. 7A is a flowchart illustrating processing performed by the load information management unit 111 according to the present exemplary embodiment.

The communication processing unit 112 controls the load information management unit 111 in response to reception of the Subscribe Request command from the client apparatus 2000. In this case, the communication processing unit 112 inputs interval information notified by the load information management unit 111 as a control parameter. The interval information used in the present exemplary embodiment includes load notification interval at which notification of the load information is performed, although the interval information is not limited to the load notification interval.

After starting the control, in step S601, the load information management unit 111 stores the load notification interval received from the communication processing unit 112. Then, the operation proceeds to step S602.

In step S602, the load information management unit 111 acquires the load information designated by the Subscribe Request command from the load information unit 113. Then, the operation proceeds to step S603.

In step S603, the load information management unit 111 transmits a Subscribe Response command including the load information acquired in step S602 to the client apparatus 2000 via the communication processing unit 112. Then, the operation proceeds to step S604.

In step S604, the load information management unit 111 is brought into a standby state and keeps the standby state until notification of the next load information is performed. It is now assumed that the condition for returning from the standby state is satisfied when the load notification interval has elapsed or when an internal event (e.g., initial setting return action, time synchronization action, backup action, own apparatus fan/power/storage error, or temperature abnormality) has occurred. If the load information management unit 111 determines that the return condition has been satisfied, the operation proceeds to step S605.

In step S605, the load information management unit 111 acquires load information again from the load information unit 113, similar to step S602. Then, the operation proceeds to step S606. In the present exemplary embodiment, it is assumed that the load information acquired in step S605 is the same as the load information acquired in step S602. However, they may be completely different from each other or may be partly differentiated when the reading processing is performed repetitively.

In step S606, the load information management unit 111 transmits a Notify command including the load information acquired in step S605 to the client apparatus 2000 via the communication processing unit 112. Then, the operation proceeds to step S607.

In step S607, the load information management unit 111 performs load notification interval resetting processing. The resetting processing performed in step S607 will be described in detail below. If the resetting processing completes, the operation proceeds to step S608.

In step S608, the load information management unit 111 confirms whether a termination instruction has been received from the client apparatus 2000 via the communication processing unit 112. If it is determined that the termination instruction has been received (YES in step S608), the load information management unit 111 terminates the processing of the flowchart illustrated in FIG. 7A. On the other hand, if the load information management unit 111 determines that the termination instruction has not been received (NO in step S608), the operation returns to step S604 (i.e., the standby state).

FIG. 7B is a flowchart illustrating the load notification interval resetting processing performed in step S607. The load information management unit 111 performs the processing according to the flowchart illustrated in FIG. 7B.

In step S610, the load information management unit 111 compares the load information acquired in step S602 (or preceding step of step S602) with the load information acquired in the immediate preceding step S605. As a comparison result, if the load information management unit 111 determines that the change (i.e., increase/decrease) amount of the load information is equal to or greater than an upper-limit threshold (YES in step S610), the operation proceeds to step S611. On the other hand, if the load information management unit 111 determines that the change amount of the load information is less than the upper-limit threshold (NO in step S610), the operation proceeds to step S612.

In step S611, the load information management unit 111 sets the load notification interval to a half of the time designated by a start-up parameter. Then, the load information management unit 111 terminates the processing of the flowchart illustrated in FIG. 7B.

In step S612, the load information management unit 111 compares the load information acquired in step S602 (or preceding step of step S602) with the load information acquired in the immediate preceding step S605. As a comparison result, if the load information management unit 111 determines that the change (i.e., increase/decrease) amount of the load information is equal to or less than a lower-limit threshold (YES in step S612), the operation proceeds to step S613. On the other hand, if the load information management unit 111 determines that the change amount of the load information is greater than the lower-limit threshold (NO in step S612), the load information management unit 111 terminates the processing of the flowchart illustrated in FIG. 7B without changing the load notification interval.

In step S613, the load information management unit 111 sets the load notification interval to two times the time designated by the start-up parameter. Then, the load information management unit 111 terminates the processing of the flowchart illustrated in FIG. 7B.

By performing the processing according to the flowcharts illustrated in FIGS. 7A and 7B, the imaging apparatus 1000 can notify the client apparatus 2000 of the load information at an appropriate timing. For example, in a case where the upper-limit threshold is set to 10% with respect to difference in the CPU usage rate and the lower-limit threshold is set to 2% with respect to difference in the CPU usage rate, if the CPU usage rate increases from 60% to 80%, the load notification interval is set to a halved time. If the CPU usage rate increases from 60% to 61%, the load notification interval is set to a doubled time. If the CPU usage rate increases from 60% to 65%, the load notification interval is not changed. Accordingly, it is possible to increase the acquisition frequency of the load information when the change amount of the load information is large and decrease the acquisition frequency when the change amount is small.

In the present exemplary embodiment, the load information management unit 111 sets the load notification interval to the halved or doubled time. However, the setting values are not limited to these values. For example, it is possible to change the load notification interval when a predetermined time has elapsed. Changing the notification interval more finely or using a more complicated algorithm is also possible.

In the present exemplary embodiment, the interval information is set as the start-up parameter for the load information management unit 111. However, the valid period information may be transmitted together therewith. In this case, in determining whether to terminate the processing in step S608, the load information management unit 111 can determine whether the valid period has elapsed as another condition to be satisfied.

Further, it is unnecessary for the communication processing unit 112 to transmit the interval information if it is possible to use interval information stationarily owned by the load information management unit 111 or stored in the storage unit 1008.

In the present exemplary embodiment, the communication processing unit 112 activates the load information management unit 111. However, it is possible to activate only the load information management unit 111 irrespective of the communication processing program 112 and perform notification processing for a plurality of clients in a batch fashion.

As described above, the client can collect and monitor a load state and an event having occurred in an apparatus connected via a network according to the ability of the apparatus.

Hereinafter, an information processing apparatus and a related processing method according to a second exemplary embodiment of the present disclosure will be described in detail below. The configurations of an imaging apparatus and others according to the second exemplary embodiment are similar to those described in the first exemplary embodiment and therefore redundant description thereof will be avoided.

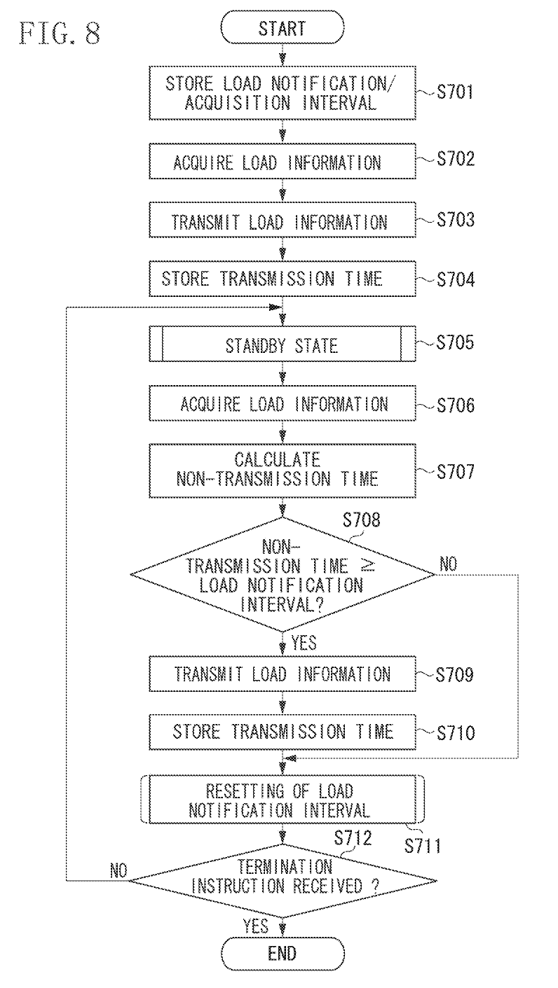

FIG. 8 is a flowchart illustrating processing performed by the load information management unit 111 according to the second exemplary embodiment.

The communication processing unit 112 controls the load information management unit 111 in response to reception of the Subscribe Request command from the client apparatus 2000. In this case, the communication processing unit 112 inputs interval information notified by the load information management unit 111, as a start-up parameter. In the present exemplary embodiment, the interval information includes the load notification interval at which the communication processing unit 112 is notified of the load information, and a load acquisition interval at which the load information is acquired from the load information resource 113.

In step S701, the load information management unit 111 stores the load notification interval and the load acquisition interval included in the interval information notified at the start-up timing. Then, the operation proceeds to step S702.

In step S702, the load information management unit 111 acquires load information designated by the Subscribe Request command from the load information unit 113. Then, the operation proceeds to step S703.

In step S703, the load information management unit 111 transmits a Subscribe Response command including the load information acquired in step S702 to the client apparatus 2000 via the communication processing unit 112. Then, the operation proceeds to step S704.

In step S704, the load information management unit 111 stores the present time (i.e., load information transmission time). The storage destination may be a temporary storage unit in the control unit 1007 or may be the storage unit 1008. Then, the operation proceeds to step S705.

In step S705, the load information management unit 111 is brought into a standby state and then keeps the standby state until notification of the next load information is performed. It is now assumed that the condition for returning from the standby state can be satisfied when the load notification interval has elapsed or when an internal event (e.g., initial setting return action, time synchronization action, backup action, own apparatus fan/power/storage error, or temperature abnormality) has occurred. If load information management unit 111 determines that the return condition has been satisfied, the operation proceeds to step S706.

In step S706, the load information management unit 111 acquires load information again from the load information unit 113. The processing performed in step S706 is similar to the processing performed in step S702. Then, the operation proceeds to step S707. In the present exemplary embodiment, it is assumed that the load information acquired in step S605 is the same as the load information acquired in step S602. However, they may be completely different from each other or may be partly differentiated when the reading processing is performed repetitively.

In step S707, the load information management unit 111 calculates a non-transmission time, which represents a difference between the previous load information transmission time to the present time. Then, the operation proceeds to step S708.

In step S708, the load information management unit 111 determines whether the non-transmission time (i.e., the time calculated in step S707) is equal to or greater than the load notification interval. If the load information management unit 111 determines that the non-transmission time is equal to or greater than the load notification interval (YES in step S708), the operation proceeds to step S709. On the other hand, if the load information management unit 111 determines that the non-transmission time is less than the load notification interval (NO in step S708), the operation proceeds to step S711.

In step S709 (i.e., if the non-transmission time is equal to or greater than the load notification interval), the load information management unit 111 transmits a Notify command including the load information acquired in step S706 to the client apparatus 2000 via the communication processing unit 112. Then, the operation proceeds to step S710.

In step S710, the load information management unit 111 stores the present time (i.e., load information transmission time). The processing to be performed in step S710 is similar to the processing performed in step S704. Then, the operation proceeds to step S711.

Processing performed in step S711 is similar to the processing performed in step S607 illustrated in FIG. 7A and therefore redundant description thereof will be avoided. Then, if the processing in step S711 completes, the operation proceeds to step S712.

In step S712, the load information management unit 111 confirms whether a termination instruction has been received from the client apparatus 2000, via the communication processing unit 112. If it is determined that the termination instruction has been received (YES in step 712), the load information management unit 111 terminates the processing of the flowchart illustrated in FIG. 8. On the other hand, the load information management unit 111 determines that the termination instruction has not been received (NO in step S712), the operation returns to step S705 (i.e., the standby state).

In the present exemplary embodiment, the interval information is set as the start-up parameter for the load information management unit 111. However, the valid period information may be transmitted together therewith. In this case, in determining whether to terminate the processing in step S712, the load information management unit 111 can determine whether the valid period has elapsed as another condition to be satisfied.

Further, it is unnecessary for the communication processing unit 112 to transmit the interval information if it is possible to use interval information stationarily owned by the load information management unit 111 or stored in the storage unit 1008.

In the present exemplary embodiment, in step S708, the load information management unit 111 determines whether the non-transmission time is equal to or greater than the load notification interval. However, if a difference between the acquired load information and the previous information is sufficiently large, the determination result in step S708 may be regarded as true even when the non-transmission time is less than the load notification interval.

In the present exemplary embodiment, the load notification interval is used to determine the timing to transmit the load information. However, the setting can be performed independent of the load information acquiring timing. In this case, enabling to set the interval information independently is desired.

In the present exemplary embodiment, the communication processing unit 112 activates the load information management unit 111. However, it is possible to activate only the load information management unit 111 irrespective of the communication processing program 112 and perform notification processing for a plurality of clients in a batch fashion.

As described above, the client can collect and monitor a load state and an event having occurred in an apparatus connected via a network according to the ability of the apparatus.

Although the present disclosure has been described with reference to preferred embodiments, the present disclosure is not limited to the illustrated exemplary embodiments and can be changed or modified in various ways within the scope of the disclosure.

### Other Embodiments

Embodiments of the present disclosure can also be realized by a computer of a system or apparatus that reads out and executes computer executable instructions recorded on a storage medium (e.g., non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-055209, filed Mar. 18, 2015, which is hereby incorporated by reference herein in its entirety.

What is claimed is:

1. An information processing apparatus capable of communicating with an external apparatus via a network, the information processing apparatus comprising:
a processing unit configured to process predetermined data including image data;
an information management unit configured to acquire, at a first interval, load information about processing load of the processing unit;
a transmission unit configured to transmit the load information acquired by the information management unit to the external apparatus, via the network, at a second interval;
a reception unit configured to receive a control command via the network; and
a control unit configured to control the first interval or the second interval,
wherein the control command includes an instruction or a parameter that is required to acquire the load information, and
wherein the control unit controls the first interval or the second interval based on a change amount of the load information.

2. The information processing apparatus according to claim 1, wherein the control unit reduces at least the first interval in a case where the change amount of the load information is greater than a predetermined amount and increases the first interval or the second interval in a case where the change amount of the load information is less than the predetermined amount.

3. The information processing apparatus according to claim 1, wherein the control unit controls the first interval or the second interval based on the parameter included in the control command received by the reception unit and the change amount of the load information.

4. The information processing apparatus according to claim 1, further comprising a storage unit configured to store a parameter used by the control unit to control the first interval or the second interval,
wherein the control unit controls the first interval or the second interval based on the parameter stored in the storage unit and the change amount of the load information.

5. The information processing apparatus according to claim 1,
wherein the control command received by the reception unit includes expiration information designating an expiration time until which the transmission unit is permitted to transmit the load information, and
wherein the control unit controls the expiration time until which the transmission unit is permitted to transmit the load information based on the expiration information included in the control command.

6. The information processing apparatus according to claim 1, wherein the load information includes at least one of CPU usage rate, initial setting return date and time, start-up/restart date and time, time synchronization date and time, backup date and time, fan/power source/storage error, and temperature abnormality.

7. The information processing apparatus according to claim 1,
wherein the control command received by the reception unit includes a request instruction that requests load information that can be acquired by the acquisition unit, and
wherein the transmission unit transmits a response to the request instruction including the load information that can be acquired by the acquisition unit.

8. The information processing apparatus according to claim 1, wherein the control command received by the reception unit includes a parameter that designates the first interval and the second interval independently.

9. The information processing apparatus according to claim 1, wherein the transmission unit transmits the load information as a response to the control command including the instruction that is required to acquire the load information received by the reception unit.

10. The information processing apparatus according to claim 1, further comprising an imaging unit configured to acquire the image data to be processed by the processing unit.

11. A method for controlling an information processing apparatus that includes a communication unit configured to communicate with an external apparatus via a network, a processing unit configured to process predetermined data including image data, and a reception unit configured to receive a control command via the network, the method comprising:
acquiring, at a first interval, load information about processing load of the processing unit;
transmitting the acquired load information to the external apparatus, via the network, at a second interval; and
controlling the first interval or the second interval,
wherein the control command includes an instruction or a parameter that is required to acquire the load information, and
wherein the first interval or the second interval is controlled based on a change amount of the load information.

12. An imaging apparatus capable of communicating with an external apparatus via a network, the imaging apparatus comprising:
a processing unit configured to process predetermined data including image data;
an imaging unit configured to acquire the image data;
an information management unit configured to acquire, at a first interval, load information about processing load of the processing unit;
a storage unit configured to temporarily store the load information acquired by the information management unit;
a transmission unit configured to transmit load information stored in the storage unit to the external apparatus via the network at a second interval;
a reception unit configured to receive a control command to control the imaging unit via the network; and
a control unit configured to control the first interval or the second interval independently.
